(19) United States
(12) Patent Application Publication
(10) Pub. No.: US 2009/0224491 A1
(43) Pub. Date: Sep. 10, 2009

(54) CHUCK WRENCH FOR A DRILL

(76) Inventor: Steven F. Thiel, Colgate, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/398,645

(22) Filed: Mar. 5, 2009

Related U.S. Application Data
(60) Provisional application No. 61/034,806, filed on Mar. 7, 2008.

(51) Int. Cl. B23B 31/12; B23B 51/00

(52) U.S. Cl. 279/62; 408/239 R

(57) ABSTRACT

A chuck wrench for use with a drill that has a keyless chuck defining a rotational axis includes a body having an interior surface defining an opening. The opening is configured to receive a portion of the keyless chuck such that the body substantially surrounds the keyless chuck. The interior surface includes a projection configured to mate with an exterior surface of the keyless chuck. The chuck wrench also includes a lever coupled to and extending from the body. The lever is operable to rotate the body about the rotational axis such that the projection engages the exterior surface of the keyless chuck to apply a clamp force to the keyless chuck.

### CROSS-REFERENCE TO RELATED APPLICATIONS

This application claims priority to U.S. Provisional Patent Application No. 61/034,806, titled “CHUCK WRENCH FOR A DRILL,” and filed Mar. 7, 2008 by Steven. F. Thiel, the entire contents of which are hereby incorporated by reference.

### BACKGROUND

The present invention relates to a chuck wrench for applying a clamp force to a chuck of a drill.

Rotary power tools, such as drills, typically include chucks for receiving and clamping an accessory (e.g., a drill bit, an adapter, a pin, etc.). Such chucks are usually rotated by hand to tighten around the accessory. However, some users may not have enough hand strength to rotate the chucks and apply a sufficient clamping force to the accessory. In addition, a user's hand may become scraped or raw when the user tries to tightly grip and rotate a chuck.

### SUMMARY

In one embodiment, the invention provides a chuck wrench for use with a drill. The drill includes a keyless chuck defining a rotational axis. The chuck wrench includes a body having an interior surface defining an opening. The opening is configured to receive a portion of the keyless chuck such that the body substantially surrounds the keyless chuck. The interior surface includes a projection configured to mate with an exterior surface of the keyless chuck. The chuck wrench also includes a lever coupled to and extending from the body. The lever is operable to rotate the body about the rotational axis such that the projection engages the exterior surface of the keyless chuck to apply a clamp force to the keyless chuck.

In another embodiment, the invention provides a power tool assembly including a power tool having a chuck defining a rotational axis. The chuck includes a first projection. The power tool assembly also includes a chuck wrench. The chuck wrench includes a body having an interior surface defining an opening. The opening receives a portion of the chuck such that the body substantially surrounds the chuck. The interior surface has a second projection that mates with the first projection of the chuck. The chuck wrench also includes a lever coupled to and extending from the body. The lever is operable to rotate the body about the rotational axis such that the second projection engages the first projection to apply a clamp force to the chuck.

### BRIEF DESCRIPTION OF THE DRAWINGS

FIG. 1 is a perspective view of a chuck wrench according to an embodiment of the invention and a chuck of an exemplary drill.

FIG. 2 is an enlarged perspective view of the chuck wrench and the chuck of the drill shown in FIG. 1.

FIG. 3 is another perspective view of the chuck wrench shown in FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

### DETAILED DESCRIPTION

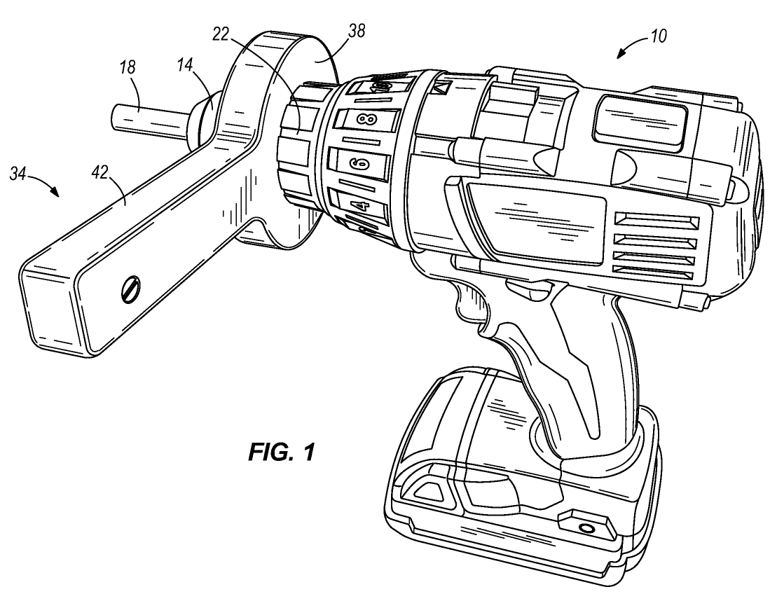

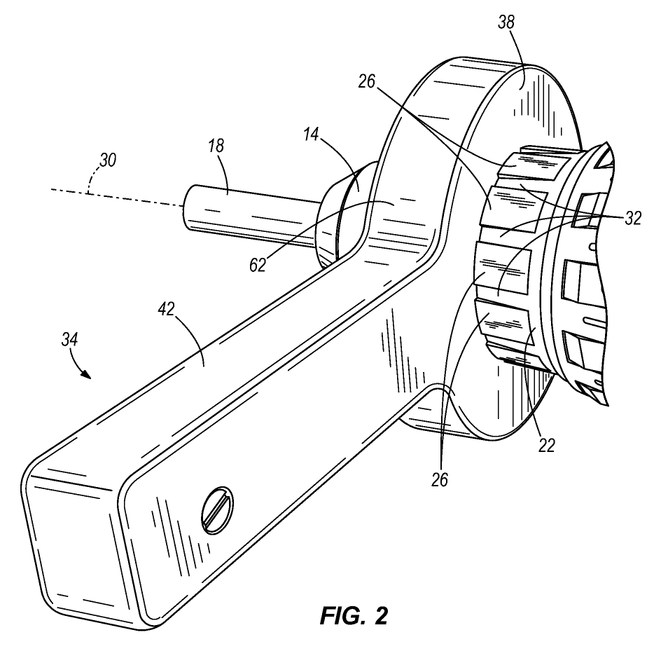

FIG. 1 illustrates an exemplary drill 10. The drill 10 is a hand-held drill that includes a keyless chuck 14 for clamping a drill accessory 18 (e.g., a drill bit, an adapter, a pin, etc.) to the drill 10. Referring to FIG. 2, the chuck 14 includes a generally cylindrical exterior, or outer, surface 22 and ribs 26 that extend radially from the exterior surface 22. The ribs 26 are spaced apart from one another about a rotational axis 30 of the chuck 14 and define recesses 32 between adjacent ribs 26. In other embodiments, the chuck 14 may include splines, keyways, or other types and shapes of projections extending from the exterior surface 22. In still other embodiments, the drill 10 may include a keyed chuck.

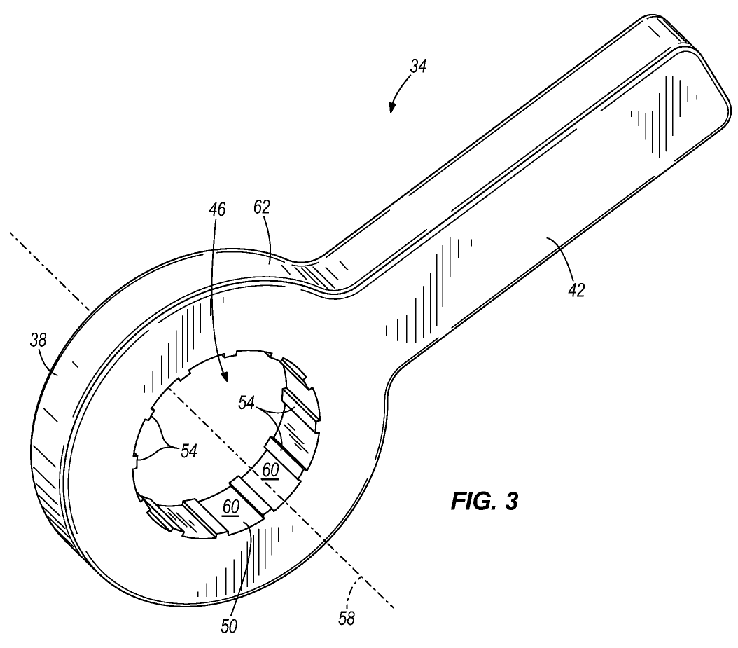

FIGS. 1-3 illustrate a chuck wrench 34 according to one embodiment of the invention. The chuck wrench 34 includes a wrench body 38 and a wrench lever 42, or handle, coupled to the wrench body 38. The wrench body 38 is generally cylindrically-shaped and defines an opening 46 (FIG. 3) that is generally circular-shaped. As shown in FIG. 3, the opening 46 is defined by an interior, or inner, surface 50 of the wrench body 38. Ribs 54 project radially inward from the interior surface 50 of the wrench body 38 toward a central axis 58 of the wrench body 38. Similar to the ribs 26 of the chuck 14, the ribs 54 of the wrench body 38 are spaced apart from one another about the central axis 58 of the wrench body 38 and define recesses 60 between adjacent ribs 54. In other embodiments, the wrench body 38 may include splines, keyways, or other types and shapes of projections extending from the interior surface 50.

As shown in FIG. 2, the shape and features (e.g., ribs 54) of the interior surface 50 of the wrench body 38 generally complement the shape and features (e.g., ribs 26) of the exterior surface 22 of the chuck 14. In particular, the ribs 54 of the chuck wrench 34 fit within the recesses 32 in the chuck 14 and the ribs 26 of the chuck 14 fit within the recesses 60 in the chuck wrench 34 such that the interior surface 50 of the chuck wrench 34 mates with the exterior surface 22 of the chuck 14. In other embodiments, the interior surface 50 of the wrench body 38 may include different patterns or designs of projections to complement and mate with the exterior surface 22 of the chuck 14. The mating of the chuck wrench 34 to the exterior surface 22 of the chuck 14 allows the chuck wrench 34 to tighten or loosen the chuck 14, and thereby clamp or release the drill accessory 18.

The wrench lever 42 of the chuck wrench 34 is a bar-like structure that is coupled to and extends from an exterior surface 62 of the wrench body 38. The wrench lever 42 provides an enlarged grip that facilitates grasping and holding the chuck wrench 34. In the illustrated embodiment, the chuck wrench 34 is made of metal, such as steel, and the wrench body 38 and the wrench lever 42 are formed as a single piece. In some embodiments, the chuck wrench 34 may be formed of other materials, such as plastic, or combinations of materials. In other embodiments, the wrench body 38 and the wrench lever 42 may be two separate pieces such that a variety of wrench levers may be removably coupled to the wrench body 38.

The chuck wrench 34 acts like a key for the chuck 14 in that it allows a user to apply a clamp force (i.e., torque) to the chuck 14 shown in FIGS. 1 and 2. The clamp force is used to either tighten or loosen the chuck 14 around the drill accessory 18. In operation, the chuck wrench 34 is slid onto the exterior surface 22 of the chuck 14 such that the interior surface 50 of the wrench body 38 frictionally couples to or mates with the exterior surface 22 of the chuck 14. A user then rotates the wrench lever 42 about the rotational axis 30 of the chuck 14, and therein the central axis 58 of the wrench body 38. Referring to FIG. 2, as the chuck wrench 34 is rotated, the ribs 54 on the interior surface 50 of the wrench body 38 engage the ribs 26 on the exterior surface 22 of the chuck 14, thereby rotating the chuck 14 directly with the chuck wrench 34. By rotating the chuck wrench 34 and therein the chuck 14, the user may either increase or decrease the clamp force (e.g., torque) presently applied to the drill accessory 18 by the chuck 14.

The wrench lever 42 acts as a mechanical lever arm by allowing a user to apply a load to the wrench lever 42, which is transmitted as torque to the chuck 14. This same load could alternatively be applied directly, by the user's hand, to the exterior surface 22 of chuck 14. However, when using the wrench lever 42, the load, or force, is applied a further distance away from the rotational axis 30, thereby increasing the torque applied to the chuck 14. When comparing the resulting clamp forces (i.e., torques) on the drill accessory 18 for the same applied load, using the chuck wrench 34 will achieve a greater clamp force (i.e., torque) than rotating the exterior surface 22 of the chuck 14 by hand.

In other embodiments, the wrench lever 42 may be actuated by mechanical machinery as opposed to a user, as described above.

In some embodiments, when the chuck wrench 34 is not in use, the chuck wrench 34 may be tethered to the tool (e.g., the drill 10) via a key holder, a chain, or a wrench holder formed of, for example, rubber. In such embodiments, the chuck wrench 34 will always be located with the tool, reducing the possibility of misplacing or losing the wrench 34. In other embodiments, the chuck wrench 34 may be stored separately from the tool.

Thus, the invention provides, among other things, a chuck wrench for applying a clamp force to a chuck of a rotary tool. Although the invention has been described in detail with reference to certain preferred embodiments, variations and modifications exist within the scope and spirit of one or more independent aspects of the invention as described. For example, in further embodiments, the chuck wrench 34 may be designed for use with other types of rotary tools, such as rotary hammers, hammer drills, or the like.

Various features and advantages of the invention are set forth in the following claims.

What is claimed is:

1. A chuck wrench for use with a drill, the drill including a keyless chuck defining a rotational axis, the chuck wrench comprising:
a body including an interior surface defining an opening, the opening configured to receive a portion of the keyless chuck such that the body substantially surrounds the keyless chuck, the interior surface including a projection configured to mate with an exterior surface of the keyless chuck; and
a lever coupled to and extending from the body, the lever operable to rotate the body about the rotational axis such that the projection engages the exterior surface of the keyless chuck to apply a clamp force to the keyless chuck.

2. The chuck wrench of claim 1, wherein the interior surface of the body includes a plurality of projections configured to mate with the exterior surface of the keyless chuck.

3. The chuck wrench of claim 1, wherein the projection is a rib projecting radially inward from the interior surface of the body.

4. The chuck wrench of claim 1, wherein the opening is generally circular-shaped.

5. The chuck wrench of claim 1, wherein the body is generally cylindrically-shaped.

6. The chuck wrench of claim 1, wherein the lever is a bar-like structure extending from the body.

7. The chuck wrench of claim 1, wherein the body and the lever are formed as a single piece.

8. A power tool assembly comprising:
a power tool including a chuck defining a rotational axis, the chuck including a first projection; and
a chuck wrench including
a body having an interior surface defining an opening, the opening receiving a portion of the chuck such that the body substantially surrounds the chuck, the interior surface having a second projection that mates with the first projection of the chuck, and
a lever coupled to and extending from the body, the lever operable to rotate the body about the rotational axis such that the second projection engages the first projection to apply a clamp force to the chuck.

9. The power tool assembly of claim 8, wherein the chuck includes a first plurality of projections and the interior surface of the body includes a second plurality of projections, wherein the second plurality of projections mates with the first plurality of projections to apply the clamp force.

10. The power tool assembly of claim 8, wherein the second projection is a rib projecting radially inward from the interior surface of the body.

11. The power tool assembly of claim 8, wherein the opening is generally circular-shaped.

12. The power tool assembly of claim 8, wherein the body is generally cylindrically-shaped.

13. The power tool assembly of claim 8, wherein the lever is a bar-like structure extending from the body.

14. The power tool assembly of claim 8, wherein the body and the lever are formed as a single piece.

15. The power tool assembly of claim 8, wherein the chuck wrench is tethered to the power tool.

16. The power tool assembly of claim 8, wherein the chuck is a keyless chuck.

17. The power tool assembly of claim 8, wherein the power tool is a drill.
